(19) United States
(12) Patent Application Publication
(10) Pub. No.: US 2020/0226054 A1
(43) Pub. Date: Jul. 16, 2020

(54) Determining Reviewers for Software Inspection

(71) Applicant: International Business Machines Corporation, Armonk, NY (US)

(72) Inventors: Frederic Lavigne, Antibes (FR); Spencer Thomas Reynolds, Austin, TX (US); Belinda Marie Vennam, Durham, NC (US); Ramratan Vennam, Durham, NC (US)

(73) Assignee: International Business Machines Corporation, Armonk, NY (US)

(21) Appl. No.: 16/247,833

(22) Filed: Jan. 15, 2019

(51) Int. Cl. G06F 11/36; G06Q 10/06; G06F 8/20; G06F 8/77

(52) U.S. Cl. CPC G06F 11/3688; G06F 8/77; G06F 8/22; G06Q 10/063112

(57) ABSTRACT

Provided are techniques for an objective determination of the most appropriate person to conduct a software inspection in a large software development project with multiple components, packages and micro-services in which individuals or small groups are each assigned specific modules. Historical information from testing of software commits is stored. An automated and objective analysis of an entire project, including the historical information is performed, revealing connections that would otherwise not be apparent between specific potential reviewers and the commit to be reviewed. Based upon the analysis, the system suggests one or more reviewers for the commit to be reviewed. An appropriate code reviewer may be a person with subject matter expertise (SME) in a related are or have more knowledge of a bigger picture and more context of the project, including knowledge of other components.

### FIELD OF DISCLOSURE

The claimed subject matter relates generally to software development and, more specifically, to techniques for determining the optimal code reviewers based upon code analysis and historical review of software commits.

### BACKGROUND OF THE INVENTION

Most large software development projects are collaborative efforts with distributed source control repositories and distributed teams with members of varying skill and expertise. The size of many such projects are so large, often exceeding millions of lines of code, that automation of the repositories is a necessity. Typically, individuals or small groups are each assigned specific modules associated with corresponding development tasks. For example, a development task may involve writing a portion of code such as a subroutine, macro, package, class and so on for a large software package.

Normally, once each participant develops his or her code to a point where they deem it to be complete or close to completion, the code is placed into some type of review process, or code review, for peer analysis and approval. Benefits of code reviews include identifying problems with logic, identifying security holes, maintaining best practices, performance optimization and consistent code formatting.

Once a coding has been completed, the subject code is included in a “commit,” typically to a development group. A commit is a group of files that have been modified and that a developer has determined to be eligible to be integrated into a project. Modification may be necessitated by a change in requirements or the identification of a defect in a particular code repository. Automatic tests such as, but not limited to, integration tests, unit tests and static analysis are then triggered to produce various metrics. Reviewers, using the metrics, review the changes associated with the commit and, if approved, a main development branch merges the commit into the current project.

### SUMMARY

Provided are techniques for an objective determination of the most appropriate person to conduct software inspection in a large software development project. Such projects may span multiple computing systems, networks and locations as well as multiple source code repositories and teams of developers with members of varying skill and expertise. Typically, large software projects are also composed of multiple components, packages and micro-services in which individuals or small groups are each assigned specific modules.

In a large project, factors that might enable a supervisor to select the most appropriate reviewer are typically not available to the supervisor but are rather only apparent from an automated and objective analysis of the entire project. For example, an appropriate code reviewer may be a person with subject matter expertise (SME) in a related area. Such a person may be able to identify unforeseen problems due to their expertise. A different reviewer may have more knowledge of a bigger picture and more context of the project, including knowledge of other components.

As the Inventors herein have realized, even with peer code review, developers may release code that contains issues or defects. Code changes in one component can cause unintended consequences in other components, consequences that neither the code developer nor the reviewer may be aware. Such dependencies are a common source of defects. Therefore, an selection of the most appropriate reviewer, based upon an objective analysis of an entire project, including, but not limited to, the SME of participants, previous related work of participants and code dependencies, enables defects to be avoided, thus making the software development project more efficient and error free.

Provided are techniques for determining an optimum reviewer for a software commit of a software development project, comprising collecting and storing code data relating to a plurality of code elements of a software development project; collecting and storing personnel data related to a plurality of potential reviewers associated with the software development project; receiving a request to identify an appropriate reviewer for a specific commit associated with the software development project; analyzing the code data and the personnel data without regard to connections between any particular developer of the plurality of reviewers with elements of the specific commit; correlating a specific reviewer based upon the analyzing; and assigning the specific reviewer to review the specific commit.

Furthermore, in this manner, the functionality or capability of computing systems is improved by possibly preventing the failure of the review and testing of components. Additionally, the functionality or capability of computing systems is improved by preventing a team of software engineers from spending time and utilizing computing resources (e.g., processing resources) in attempting to identify and understand the errors that typically occur in any software development project. By reducing the amount of computing resources being utilized by software developers from identifying and understanding development errors, computing resources (e.g., processing resource) are more efficiently utilized.

Furthermore, the present invention improves the technology or technical field involving software development. As discussed above, the claimed subject matter breaks the selection of an appropriate reviewer into stages, such as collecting data, analyzing the date, correlating the analysis to portions of software under development and scoring and selecting the most appropriate review in software projects that typically span multiple computing device, locations and development teams. Each stage is aimed at verifying the quality of new features from a different angle to validate the new functionality and prevent errors from affecting the software. The present invention improves such technology by creating an objective model for the selection of a reviewer. In this manner, confidence score(s) predicting the likelihood of the software application completing the development phase with a minimum of errors can be determined thereby be accomplished. In this manner, there is an improvement to the technology or technical field involving software development.

In addition, the technical solution provided by the present invention cannot be performed in the human mind or by a human using a pen and paper. That is, the technical solution provided by the present invention could not be accomplished in the human mind or by a human using a pen and paper in any reasonable amount of time and with any reasonable expectation of accuracy without the use of a computer.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of an example of a Commit Review System (CRS) Architecture (CRSA) that may implement the claimed subject matter.

FIG. 2 is a block diagram of a Source Control & Review Server (SCRS) first introduce in FIG. 1 in more detail.

FIG. 3 is a block diagram of examples of elements of the CRS Architecture of FIG. 1 and the data flow among those elements.

FIG. 4 is an example of a flowchart of a Review Commit process that may implement the claimed subject matter.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be understood that the following examples and descriptions are simplified for the sake of convenience and used for descriptive purposes only. Those with skill in the relevant arts will appreciate that a typical project may span multiple computing systems, networks and locations as well as multiple source code repositories and teams of developers with members of varying skill and expertise. Further, large software projects are typically composed of multiple components, packages and micro-services in which individuals or small groups are each assigned specific modules. The complexity of such projects prevents any single individual from understanding all the connections between the components, thus necessitating the disclosed technology.

One current approach to determining an appropriate reviewer is to select the most veteran, experienced person on a team. However, this person's talents might be more efficiently employed in another task. Another approach is to select a reviewer based upon a history of the commits to the particular files under review. For example, a reviewer who has worked on the specific code. This approach ignores any reviewer that has not previously made changes to the affected code, even though their components might be the most affected.

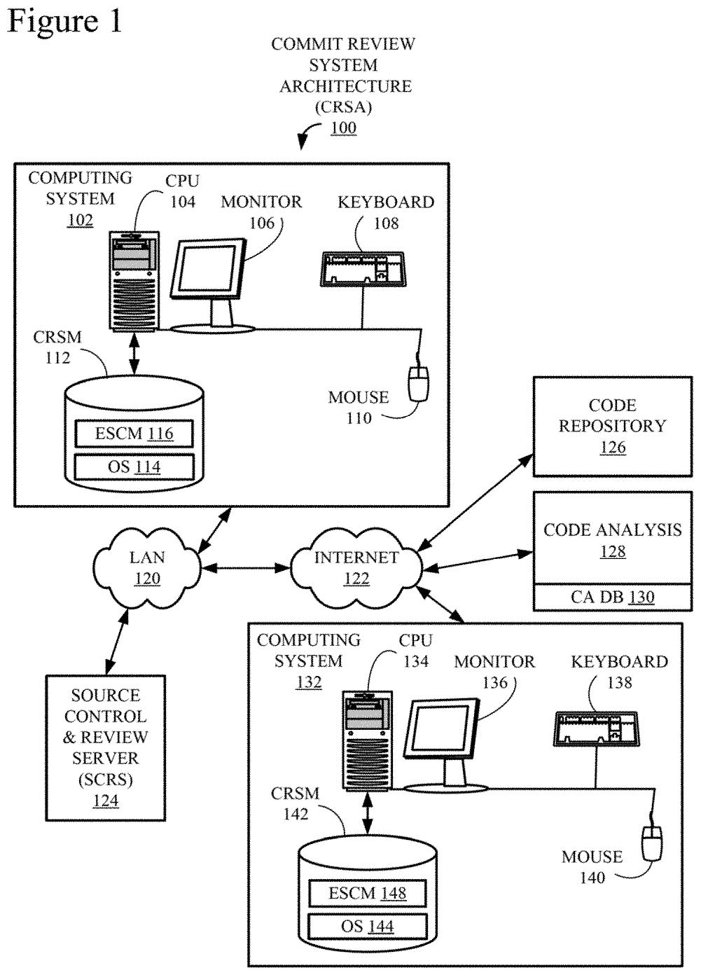

FIG. 1 is a block diagram of an example of a Commit Review System (CRS) Architecture (CRSA) 100 that may implement the claimed subject matter. A computing system 102 includes a central processing unit (CPU) 104, coupled to a monitor 106, a keyboard 108 and a pointing device, or “mouse,” 110, which together facilitate human interaction with computing system 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an operating system (OS) 114 and a Editing and Source Control Module component, or simply ESCM 116. ESCM 116 works in conjunction with a Source Control and Review Server (SCRS) 124 as a client, typically on a developer's computing device.

Computing system 102 and CPU 104 are connected to a Local Area Network (LAN) 120, which provides connectivity to the Internet 122. Source Control and Review Server (SCRS) 124 is communicatively coupled to LAN 120 and via network 120 to the Internet 122.

Also coupled to the Internet 122 are a Code Repository 126 and a Code Analysis 128. Code Repository 126 stores the actual code under development and data concerning the code. Code Analysis 128 performs tasks such as, but not limited to, integration testing, unit testing and static analysis, which evaluate code complexity, validate code against a set of rules, detect unreachable code that should be removed, determine which parts of a codebase are executed during tests and generate metrics and insights on the overall source code. In one embodiment of the claimed subject matter SCRS 124 monitors the output of Code Analysis (CA) 128 and aggregates the data into a CA database 130.

Database 130 contains, in addition to static analysis and code coverage information, the connections among code artifacts. To establish the connections between code artifacts, database 130 is initialized with historical data from source repository 126. Historical data includes, but is not limited to, information on commits, existing bug tracking issues, the developers associated with commits and bug fixes, modified files and the configuration of modules and their owners. CA database 130 is updated with the new or modified data whenever a change occurs in the code or a connected system. By maintaining a history of the output of Code Analysis 128, SCRS 124 is able to consider new analysis results and is able to suggest appropriate code reviewers that may not be apparent in a typical reviewer selection process.

Also connected to Internet 122 is a second computing system 132. Like computing system 102, computing system 132 includes a CPU 134, a monitor 136, a keyboard 138, a mouse 140 and a CRSM 142. CRSM 142 is illustrated storing an OS 144 and a ESCM component, or simply ESCM 148. Although in this example, computing systems 102 and 132, SCRS 124, Code Repository 126 and Code Analysis 128 are communicatively coupled via one or both LAN 120 and the Internet 122, they could also be coupled through any number of communication mediums such as, but not limited to, a wide area network (WAN) (not shown), direct wire and wireless systems.

CRSA 100 is merely used as one example of an architecture that would support a large-scale, distributed software development project. It should be noted there are many possible computing system configurations, of which CRSA 100 is only one simple example. A typical system would likely have many more components as a distributed, software development system might be include the work of hundreds of individuals spread over dozens of locations. In addition, some illustrated components such as SCRS 124 may be comprised as multiple components and hosted by multiple server computing devices. The particular components shown in FIG. 1 are merely used as examples throughout the remainder of the Description.

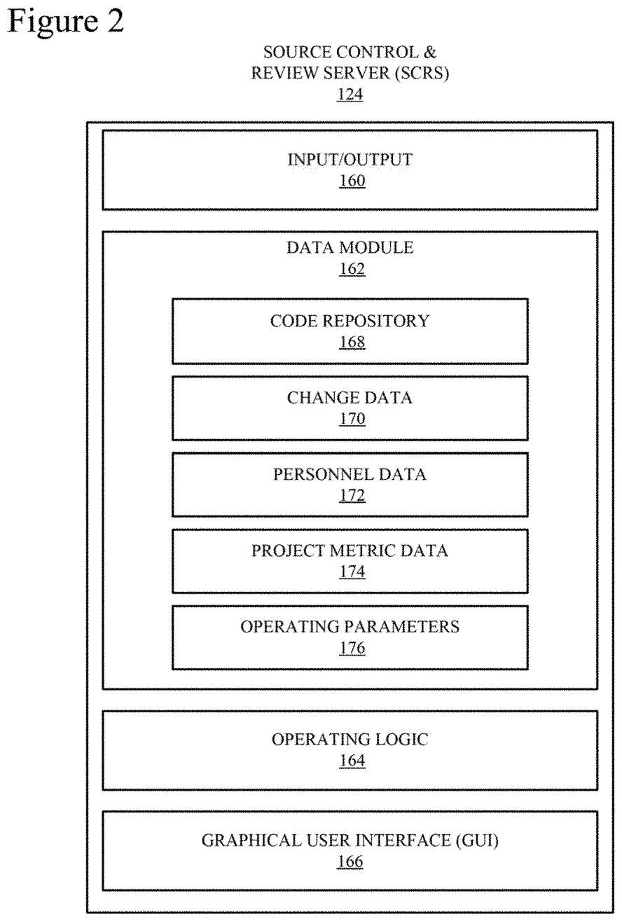

FIG. 2 is a block diagram of SCRS 124, first introduced above in conjunction with FIG. 1. SCRS 124 includes an input/output (I/O) module 160, a data module 162, operating logic 164 a graphical user interface module, or simply “GUI,” 166. For the sake of the following examples, logic associated with SCRS 124 is assumed to be stored on a non-transitory computer-readable storage media (not shown) and execute on one or more processors (not shown) of a server computer (not shown). It should be understood that the claimed subject matter can be implemented in many types of computing systems and data storage structures but, for the sake of simplicity, is described only with respect to CRSA 100 (FIG. 1). Further, the representation of SCRS 124 in FIG. 2 is a logical model. In other words, components 160, 162, 164 and 166 may be stored in the same or separates files and loaded and/or executed within components of architecture 100 either as a single system or as separate processes interacting via any available inter process communication (IPC) techniques. In addition, functionality of SCRS 124 may be provided by a single server computing device (not shown) that provides the disclosed subject matter concurrently to multiple developers located in multiple locations. In this manner, many issues related to large scale, distributed software development projects may be either eliminated of mitigated.

I/O module 160 handles any communication SCRS 124 has with other components of architecture 100, including, in this description, computing systems 102 and 132 (FIG. 1) and any developers and reviewers associated with a large, distributed software development project.

Data module 162 is a data repository for stored code and personnel data for implementing the claimed subject matter. Examples of the types of information stored in data module 162 include a code repository 168, change data 170, personnel data 172, project metric data 174 and operating parameters 176. In this example, code repository 168 stores actual computing code under development. Change data 170 stores information related to changes that have been made to the code data stored in code repository 168. In addition to providing the ability to “roll back” changes made to code repository 168, change data stores references to entries in personnel data 172 to enable implementation of the claimed subject matter. Personnel data 172 stores information relating to the developers and reviews associated with any particular software development project. Such data may include, but is not limited to, contact information, work and subject matter experience and references to the specific code with which a developer or reviewer may have been involved.

Project metric data 174 stores information relating to the overall structure of a software project under development. Examples of the type of information stored in code organization data 174 includes, but is not limited to, identification and classifications of code elements such as subroutines, macros, packages, classes and so. Classifications of code elements might include identifying particular types of code according to the specific function they provide. For example, code relating to network communication may have be assigned a particular identifier so that the SCRS 124 can identify a reviewer who has expertise in a particular subject matter and relate that reviewer to portions of code with which the reviewer has not had any involvement.

Operating parameters 176 includes information on various user and administrative preferences that have been set. For example, an administrator may set parameters to give more weight to particular elements of personnel data 172 or code organization data 174 to be employed in an analysis and determination of the best reviewers for a particular code review or commit.

Operating logic 164 stores the logic that implements SCRS 124. GUI 166 provides an interface for administrators to view and edit operating elements of data module 162, including personnel data 172, project metric data 174 and operating parameters 176.

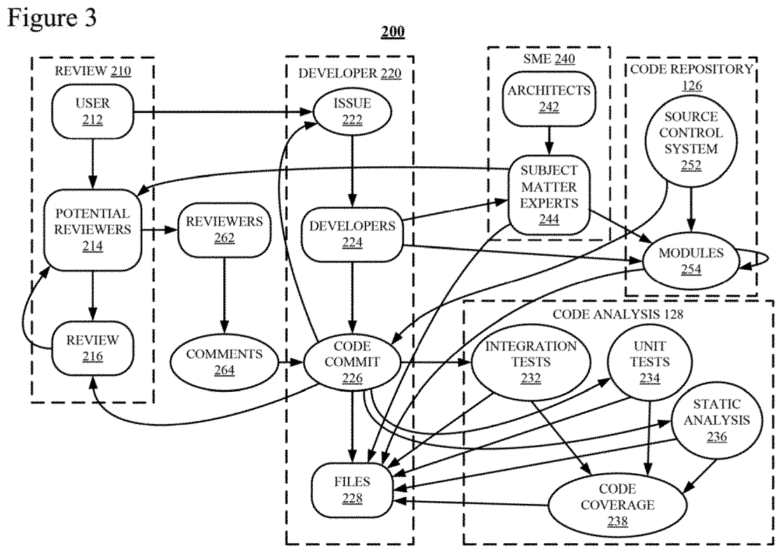

FIG. 3 is a Data Flow diagram 200 showing elements of CRS Architecture 100 of FIG. 1 and the data flow among those elements. The elements of CRS Architecture 100 are organized into several categories, i.e., a Review category 210, a Developer category 220, Code Analysis 128 (FIG. 1), a Subject Matter Expert (SME) category 240 and Code Repository 126 (FIG. 1).

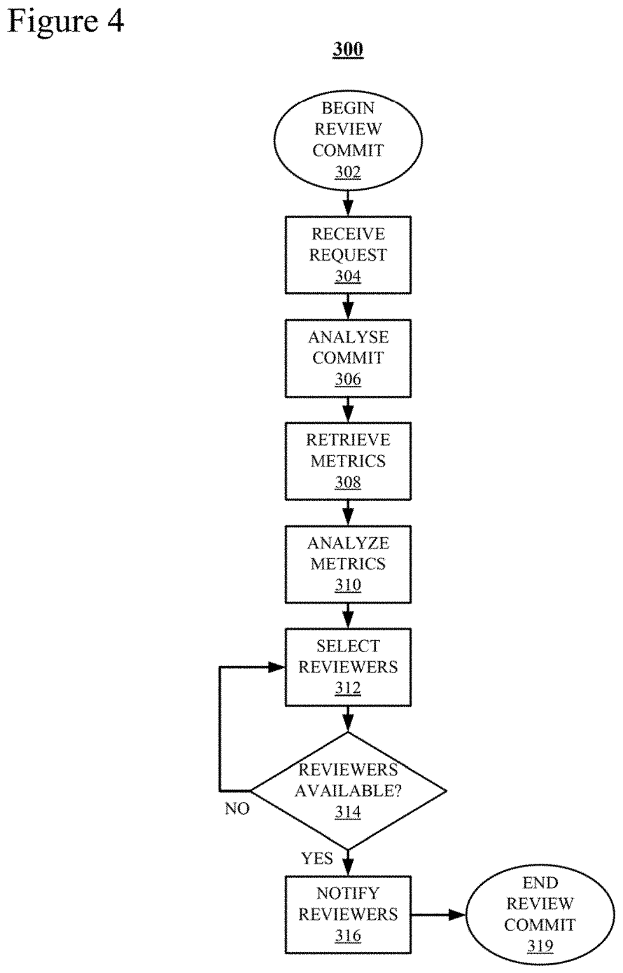

Review 210 includes a User 212, Potential Reviewers 214 and a Review 216. User 212 represents parties that might employ the claimed system or one of a pool of users that might be considered Potential Reviewers 214. Any one of Potential Reviewers 214 may accept or decline the assignment of a Review 216. Once at least one of Potential Reviewers 214 has been selected in accordance with the disclosed technology and accepted the assignment, the selected reviewers, or Reviewers 262, produces Comments 264. Reviewers 262 and Comments 264 are described in more detail below in conjunction with FIG. 4.

Developer 220 includes an Issue category 222, a Developers category 224, a Code Commit category 226 and a Files category 228. Issue 222 represents a problem, a defect, an enhancement or a new feature with respect to the software project under development that needs to be addressed. Once an issue has been reported by User 212, one or more developers represented by Developers 224 are assigned to address the issue or problem. Work product of Developers 224 becomes a Commit 226 which is stored in Files 228. As explained above a commit is a group of files that have been modified and are ready to be integrated into a project. Code Commit 226 triggers testing, specifically Integration Tests 232, Unit Tests 234 and Static Analysis 236 of Code Analysis 128. Integration Tests 232, Unit Tests 234 and Static Analysis 128 produce Code Coverage 238. Results of Integration Tests 232, Unit Tests 234, Static Analysis 236 and Code Coverage 238 are stored in Files 228. It should be understood that elements 232, 234 and 236 are provided as examples and that tests and analysis in addition to Integration and Unit Tests 232, 234 and Static Analysis 236 may also be pertformed.

SME category 240 represents parties that might have an expertise with any particular portion of the project under development. Such parties may include, but are not limited to, an Architects 242, or the designers of a project, and Developers 224, who generate the code. Parties associated with Architects 242 and Developers 224 are considered Subject Matter Experts (SMEs) 244. The identities, qualifications and specific areas of expertise for each part represented by Architects 242 and Developers 224 are also stored in Files 228. In addition, parties associated with SME 244 are transmitted to Potential Reviewers 214 to be employed in the selection of appropriate reviewers of a particular commit.

Code Repository 126 includes logic corresponding to a Source Control System 252. SCS 252 tracks changes to the project software and enables Developers 224 to revert, or rollback, changes that have been rejected. SCS 252 manages Modules 254, which is the most current version of the project. Information associated with Modules 254 is also stored in Files 228. In this manner, Files 228, which stores information from elements 232, 234, 236 and 238 of Code Analysis 128, information associated with Modules 254 and SME 240 and Code Commit 226 is able to provide a more complete analysis for the determination of the most appropriate party of Reviewers 262 to review a particular commit.

Finally, once the most appropriate party of Reviewers 262 has been assigned the task of reviewing the current Code Commit 226, the party produces Comments 264 that are incorporated into Code Commit 226 prior to the actual implementation.

FIG. 4 is an example of a flowchart of a Review Commit process 300 that may implement the claimed subject matter. In this example, logic associated with process 300 is stored on a non-transitory, computer-readable storage medium (CRSM) (not shown) and executed on processors (not shown) associated with SCRS 124 (FIG. 1).

Process 300 starts in a “Begins Review Commit” block 302 and proceeds immediately to a “Receive Request” block 304. In this example, during processing associated with block 304, SCRS 124 (FIGS. 1&2) receives notification of a proposed Code Commit 226 (FIG. 3). During processing associated with an “Analyze Commit” block 306, as explained above in conjunction with FIG. 3, Code Commit 226 triggers Code Analysis 128, including, but not limited to, Integration Tests 232, Unit Tests 234 and Static Analysis 236, which produce, among other information, information on Code Coverage 238. This information is saved in Files 228 (FIG. 3).

During processing associated with a “Retrieve Metrics” block 308, SCRS 124 retrieves and then analyzes, during processing associated with an “Analyze Metrics” block 310, data (see 162, FIG. 2) for selecting one or more potential reviewers.

During processing associated with a “Select Reviewers” block 312, one or more reviewers 262 (FIG. 3) are selected to produce Comments 264 (FIG. 3). The selection is based upon all the available information, including but not limited to, the SME of participants, previous related work of participants and code dependencies. During processing associated with a “Reviewers Available?” block 314, the availability of each potential reviewer identified during processing associated with block 312 is determined. If a determination is made that particular selected reviewers are not available, control returns to block 312, during which additional reviewers may be selected. If reviewers are determined to be available, control proceeds to a “Notify Reviewers” block 316. During processing associated with block 316, the available reviewers determined during processing associated with block 314 are notified of their assignment to produce Comments 264. Finally, control proceeds to an “End Review Commit” block 319 in which processing is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. An apparatus for determining an optimum reviewer for a software commit of a software development project, comprising:
a processor;
a non-transitory computer-readable storage medium; and
instructions stored on the computer-readable storage medium and executed on the processor for performing a method, the method comprising:
collecting and storing code data relating to a plurality of code elements of a software development project, wherein code data includes identification and classification of code elements based on a specific function of the code element;
collecting and storing personnel data related to a plurality of potential reviewers associated with the software development project;
receiving a request to identify an appropriate reviewer for a specific commit associated with the software development project;
analyzing the code data and the personnel data without regard to connections between any particular developer of the plurality of reviewers with elements of the specific commit;
correlating a specific reviewer based upon the analyzing; and
assigning the specific reviewer to review the specific commit.

9. The apparatus of claim 8, the collecting and storing code data comprising:
collecting code data corresponding to the specific commit; and
collecting code data corresponding to a plurality of previous code commits.

10. The apparatus of claim 8, the collecting and storing code data comprising the execution of automated code testing.

11. The apparatus of claim 10, wherein the automated testing is one or more tests selected from a list, the list comprising:
integration testing; and
unit testing.

12. The apparatus of claim 8, wherein the potential reviewers are selected from a list, the list comprising:
architects associated with the software development project;
developers associated with the project; and
subject matter experts.

13. The apparatus of claim 8, the method further comprising:
determining that the specific reviewer is available to review the specific commit; and
if the specific reviewer is available, notifying the specific reviewer; otherwise
repeating the method to select an alternative reviewer.

14. The apparatus of claim 8, the method further comprising integrating the specific commit into the software development project upon a review by the specific reviewer.

15. A computer programming product for determining an optimum reviewer for a software commit of a software development project, comprising a non-transitory computer-readable storage medium having program code embodied therewith, the program code executable by a plurality of processors to perform a method comprising:
collecting and storing code data relating to a plurality of code elements of a software development project, wherein code data includes identification and classification of code elements based on a specific function of the code element;
collecting and storing personnel data related to a plurality of potential reviewers associated with the software development project;
receiving a request to identify an appropriate reviewer for a specific commit associated with the software development project;
analyzing the code data and the personnel data without regard to connections between any particular developer of the plurality of reviewers with elements of the specific commit;
correlating a specific reviewer based upon the analyzing; and
assigning the specific reviewer to review the specific commit.

16. The computer programming product of claim 15, the collecting and storing code data comprising:
collecting code data corresponding to the specific commit; and
collecting code data corresponding to a plurality of previous code commits.

17. The computer programming product of claim 15, the collecting and storing code data comprising the execution of automated code testing.

18. The computer programming product of claim 17, wherein the automated testing is one or more tests selected from a list, the list comprising:
integration testing; and
unit testing.

19. The computer programming product of claim 15, wherein the potential reviewers are selected from a list, the list comprising:
architects associated with the software development project;
developers associated with the project; and
subject matter experts.

20. The computer programming product of claim 15, the method further comprising:
determining that the specific reviewer is available to review the specific commit; and
if the specific reviewer is available, notifying the specific reviewer; otherwise
repeating the method to select an alternative reviewer.
